(19) United States
(12) Patent Application Publication
(10) Pub. No.: US 2007/0158216 A1
(43) Pub. Date: Jul. 12, 2007

(54) CD storage sleeve preventing CD from dropping by clamping of points

(75) Inventor: Chun-Fu Lin, Taipei (TW)

Correspondence Address: BRUCE H. TROXELL;SUITE 1404, 5205 LEESBURG PIKE, FALLS CHURCH, VA, 22041, US

(73) Assignee: Handsfull Technology Corp.

(21) Appl. No.: 11/329,148

(22) Filed: Jan. 11, 2006

(51) Int. Cl. B65D 85/30; B42F 13/00

(52) U.S. Cl. 206/308.1; 402/79

(57) ABSTRACT

A CD storage sleeve for a compact disc mainly has at two lateral sides or at least at one side in a horizontal diametric direction of the compact disc a stop point pointing inwardly in order that the width of the CD storage sleeve at the area where the points are is nearly the diameter of the compact disc to thereby prevent the compact disc placed in from dropping but not to impede placing in of the compact disc; thereby a CD storage sleeve able to prevent the compact disc from dropping by clamping of a plurality of points is formed.

### BACKGROUND OF THE INVENTION

1. Field of the invention

The present invention is related to a CD storage sleeve, and especially to a CD storage sleeve able to prevent a compact disc from dropping by clamping of a plurality of points.

2. Description of the prior art

Compact discs such as often seen CD storage discs, CDROM's, VCD's and DVD's etc have been a mainstream for being data carriers nowadays. Compact discs were placed in hard plastic boxes called as “jewel boxes”. By virtue that these plastic boxes occupy quite a large space, it is not beneficial to storing.

Afterwards, there was the designing of CD storage sleeves which are soft squares or of some other shapes each with a size slightly larger than that of a compact disc for storing the latter. The left, right and bottom edges of each CD storage sleeve are closed such as by heat sealing; the upper edge has an opening for the convenience of placing in of the compact disc. The inner layer of the CD storage sleeve contacting with the data loading—in face of the compact disc is preferably made from non-woven fabric in order to prevent the compact disc from damage by abrading.

FIG. 1 shows a normally used CD storage sleeve 90 for a compact disc 93, an inner layer 92 of non-woven fabric of the CD storage sleeve 90 has a surface layer 91; the peripheries of the inner layer 92 and the surface layer 91 are all closed. The surface layer 91 is formed thereon a “V” shaped opening 911, the transverse upper opening 911 allows extending therein of the compact disc 93, so that the compact disc 93 can be accommodated in the CD storage sleeve 90. The “V” shaped bottom of the “V” shaped opening 911 preferably can reveal the central round hole of the compact disc 93 placed in, so that the compact disc 93 can be conveniently taken out; however, in order to prevent the compact disc 93 from sliding out of the “V” shaped opening 911, a downwardly extending arched sheet 912 is formed above the “V” shaped opening 911 to cover the upper portion of the compact disc 93 and to prevent the compact disc 93 from sliding out.

Nevertheless, the arched sheet 912 to prevent the compact disc 93 from sliding out the CD storage sleeve 90 of the compact disc 93 is subjected to scrape and damage the data loading in face of the compact disc 93 when the compact disc 93 is placed in or taken out, and the action of placing in or taking out of the compact disc 93 is often impeded by the arched sheet 912, this is the main shortage of the conventional CD storage sleeve of the compact disc and is necessary to be gotten rid of.

### SUMMARY OF THE INVENTION

The present invention makes improvement on a CD storage sleeve for a compact disc in view of the above stated technical shortage, and gives a design of a CD storage sleeve able to prevent a compact disc from dropping by clamping of a plurality of points. The CD storage sleeve for a compact disc mainly has at two lateral sides or at least at one side in a horizontal diametric direction of the compact disc a stop point pointing inwardly in order that the width of the CD storage sleeve at the area where the points are is nearly the diameter of the compact disc to thereby prevent the compact disc placed in from dropping but not to impede placing in of the compact disc.

The main object of the present invention is to provide a CD storage sleeve able to prevent a compact disc from dropping by clamping of a plurality of points, wherein the stop points can be provided at the time when the inner and the outer layers of the CD storage sleeve of the compact disc are connected by melting, this will not increase the cost of production.

Another object of the present invention is to provide a CD storage sleeve able to prevent a compact disc from dropping by clamping of a plurality of points, wherein a “V” shaped opening does not need a conventional arched sheet 912 to prevent the compact disc from sliding out, thus the shortage of the conventional CD storage sleeve to scrape and damage the compact disc will not exist.

The present invention will be apparent in its structural feature and effect of using after reading the detailed description of the preferred embodiment thereof in reference to the accompanying drawings.

### BRIEF DESCRIPTION OF THE DRAWINGS

FIG. 1 is a plan view of a conventional CD storage sleeve for a compact disc;

FIG. 2 is a plan view of an embodiment of a CD storage sleeve for a compact disc of the present invention; FIG. 3 is a plan view showing the embodiment of a CD storage sleeve for a compact disc of FIG. 2 of the present invention in placing in the compact disc;

FIG. 4 is a plan view showing another embodiment of a CD storage sleeve for a compact disc of the present invention;

FIG. 5 is a plan view showing a further embodiment of a CD storage sleeve for a compact disc of the present invention;

FIG. 6 is a plan view showing an embodiment of a CD storage sleeve set for two compact discs of the present invention;

FIG. 7 is a plan view showing an embodiment of a CD storage sleeve set in a butterfly shape for two compact discs of the present invention;

FIG. 8 is a plan view showing an embodiment of a CD storage sleeve set for four compact discs of the present invention.

### DETAILED DESCRIPTION OF THE PREFERRED EMBODIMENT

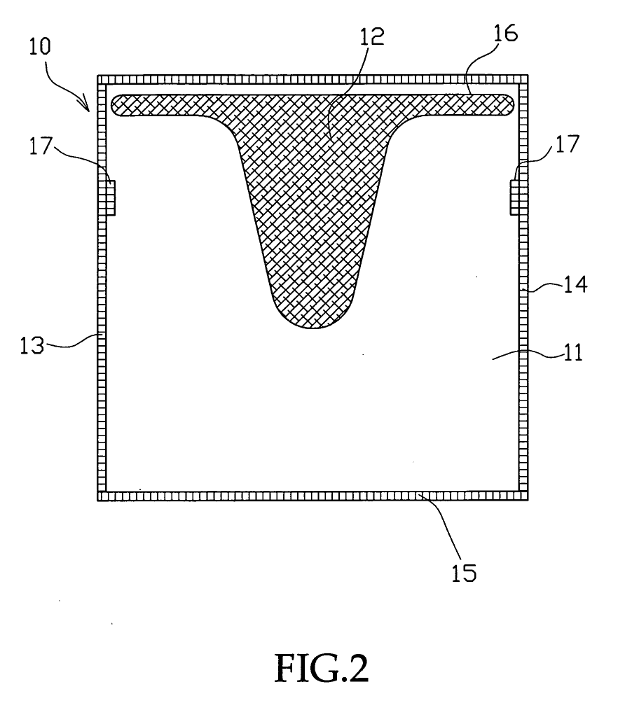

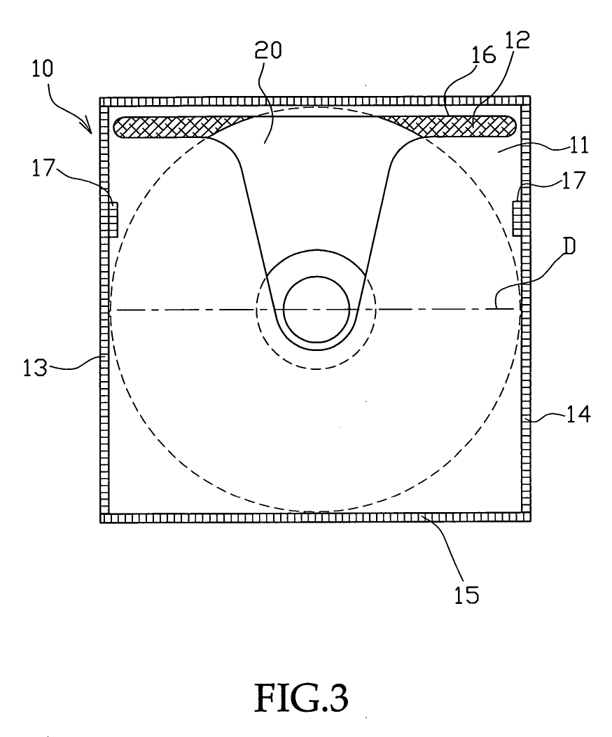

Referring to FIGS. 2, 3 showing a first preferred embodiment of the present invention, wherein a CD storage sleeve 10 for a compact disc 20 at least is composed of an outer layer 11 and an inner layer 12, of which at least the left edge 13, right edge 14 and the bottom edge 15 are closed, the upper edge has an opening 16 for the convenience of placing in of the compact disc 20. The closed left edge 13 and right edge 14 are provided in a horizontal diametric direction “D” of a compact disc 20 stop points 17 pointing inwardly, the width of the CD storage sleeve at the area where the points 17 are is reduced and nearly is equal to the diameter of the compact disc 20 to thereby prevent the compact disc placed in from dropping but not to impede placing in of the compact disc.

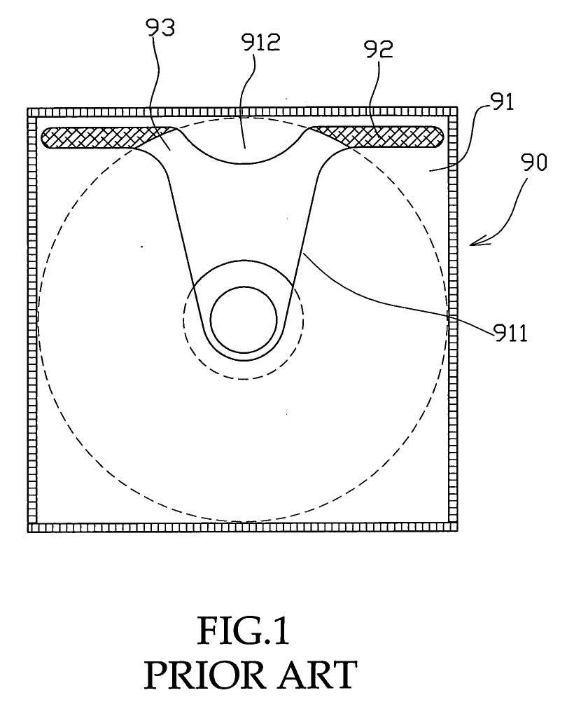

In the preferred embodiment shown in FIG. 2, the opening 16 is in a “V” shape, the lowermost position of the “V” shape can reveal a central round hole 21 of the compact disc 20 placed in, so that the compact disc 20 can be conveniently taken out. As compared with the conventional technique as shown in FIG. 1, evidently the arched sheet 912 is absent, the compact disc 20 is not subjected to scrape and damage. However, the arched sheet can also be added in some other embodiment of the present invention.

In the preferred embodiment shown, the upper edge of the outer layer 11 also is closed, while the opening 16 can be extended to the upper edge of the outer layer 11, which opening 16 is not closed.

Certainly, the CD storage sleeve 10 for the compact disc 20 can be a two-side CD storage sleeve, i.e., another outer layer same as the outer layer 11 can be added to the back of the inner layer 12, and the back side can also be placed therein with another compact disc.

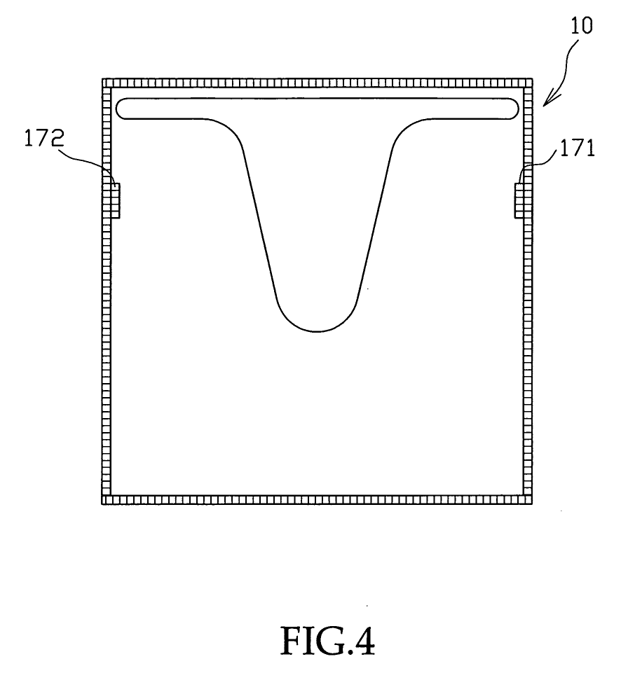

Further referring to FIG. 4, two stop points 171 and 172 can be provided on the CD storage sleeve 10 respectively at different levels; this design is beneficial to easy placing in of the compact disc.

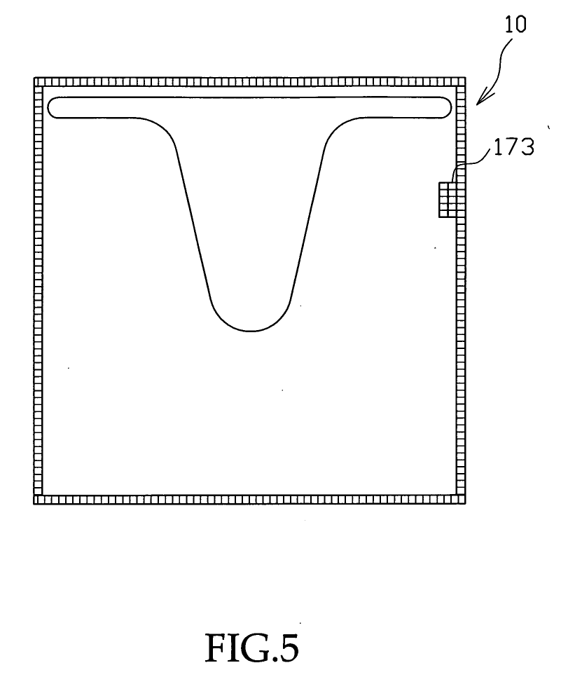

Referring to FIG. 5, a stop point 173 can be provided on the CD storage sleeve 10 only on an inner rim of its left or right edge, but this is enough for preventing sliding out of the compact disc. And this is a simple variation of the present invention; surely, the inner rim of the left or right edge can also be provided with more than two stop points.

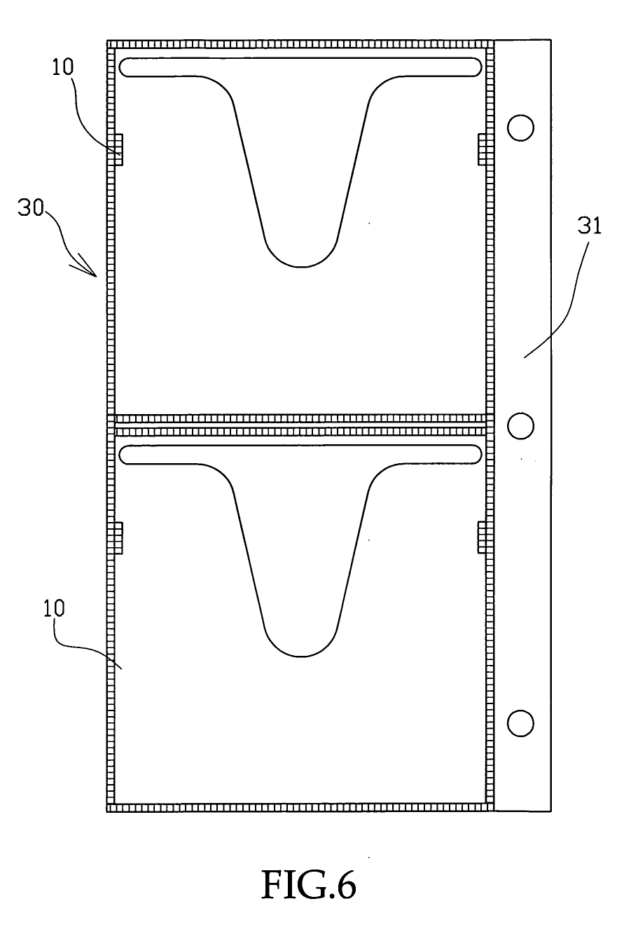

And the technique of the present invention surely can be used to an embodiment of a CD storage sleeve set 30 with a binding edge 31 for two compact discs. Wherein two CD storage sleeves 10 are in an upper and lower mode of arrangement, such as is shown in FIG. 6. Each CD storage sleeves 10 can also be a two-side CD storage sleeve as stated above.

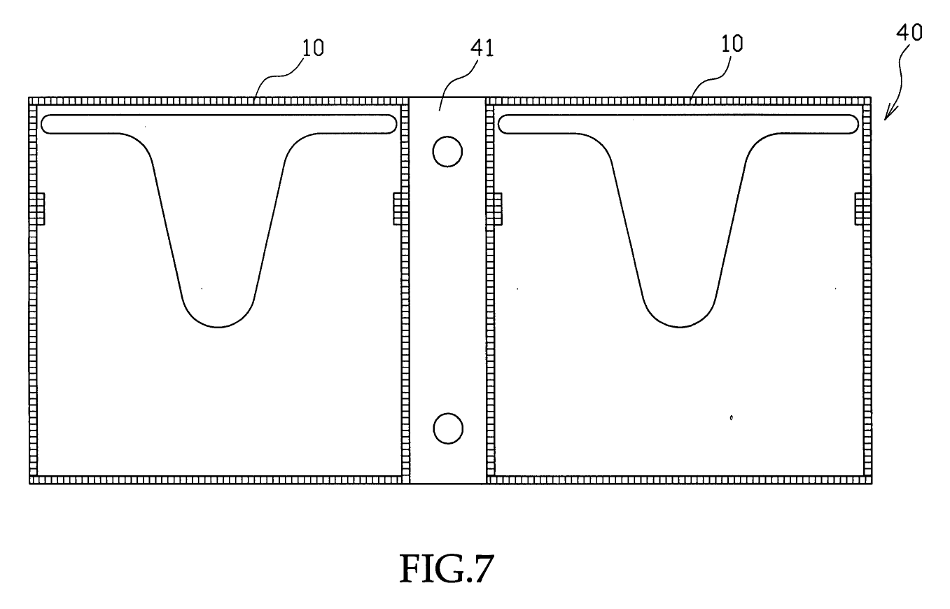

In FIG. 7, the technique of the present invention is used for a CD storage sleeve set 40 in a butterfly shape having a middle binding edge 41 and composed of two storage sleeves 10 in a right and left mode of symmetrical arrangement. Likewise, each CD storage sleeves 10 can also be a two-side CD storage sleeve as stated above.

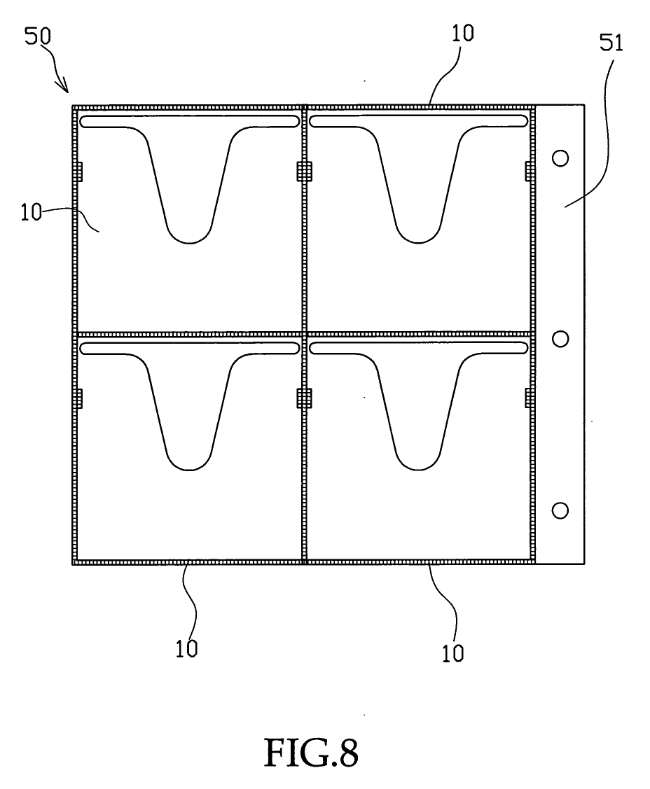

In FIG. 8, the technique of the present invention is used for a CD storage sleeve set 50 having a binding edge 51 and composed of four storage sleeves 10; the four storage sleeves 10 are distributed at four corners. Likewise, each CD storage sleeves 10 can also be a two-side CD storage sleeve as stated above.

We can see from the above embodiments that the present invention can be applied for a CD storage sleeve set including plural storage sleeves, such as six, eight storage sleeves etc.; all such modifications and changes shall fall within the scope of the appended claims.

1. A CD storage sleeve preventing a compact disc from dropping by clamping of points, said CD storage sleeve at least is composed of an outer layer and an inner layer, of which at least a left edge, a right edge and a bottom edge are closed, an upper edge has an opening for the convenience of placing in of said compact disc; said CD storage sleeve is characterized in that: said left edge and said right edge or at least one of them is provided in a horizontal diametric direction of said compact disc at least a stop point pointing inwardly, width of said CD storage sleeve at an area having said point is reduced and nearly is equal to a diameter of said compact disc to thereby prevent said compact disc placed in from dropping but not to impede placing in of said compact disc.

2. The CD storage sleeve preventing a compact disc from dropping by clamping of points as claimed in claim 1, wherein said left edge and said right edge are respectively provided at different levels with one of said stop points.

3. The CD storage sleeve preventing a compact disc from dropping by clamping of points as claimed in claim 1, wherein another outer layer same as said outer layer is added to a back of said inner layer to form a two-side CD storage sleeve.

4. The CD storage sleeve preventing a compact disc from dropping by clamping of points as claimed in claim 1, wherein said opening is in a “V” shape, the lowermost position of said “V” shape is adapted to revealing a central round hole of said compact disc placed in.

5. A CD storage sleeve set with two CD storage sleeves for two compact discs and with a binding edge, wherein each of said CD storage sleeves at least is composed of an outer layer and an inner layer, of which at least a left edge, a right edge and a bottom edge are closed, an upper edge has an opening for the convenience of placing in of one of said compact disc; said CD storage sleeve is characterized in that: said left edge and said right edge or at least one of them is provided in a horizontal diametric direction of said compact disc at least a stop point pointing inwardly, width of said CD storage sleeve at an area having said point is reduced and nearly is equal to a diameter of said compact disc to thereby prevent said compact disc placed in from dropping but not to impede placing in of said compact disc.

6. The CD storage sleeve set with two CD storage sleeves for two compact discs as claimed in claim 5, wherein another outer layer same as said outer layer is added to a back of said inner layer of each of said CD storage sleeves to form a two-side CD storage sleeve.

7. The CD storage sleeve set with two CD storage sleeves for two compact discs as claimed in claim 5, wherein said two CD storage sleeves are in an upper and lower mode of arrangement with said binding edge at one side of them.

8. The CD storage sleeve set with two CD storage sleeves for two compact discs as claimed in claim 5, wherein said CD storage sleeve set has a middle binding edge and composed of said two storage sleeves in a right and left mode of symmetrical arrangement.

9. A CD storage sleeve set with multiple CD storage sleeves for more than four compact discs and with a binding edge, wherein each of said CD storage sleeves at least is composed of an outer layer and an inner layer, of which at least a left edge, a right edge and a bottom edge are closed, an upper edge has an opening for the convenience of placing in of one of said compact discs; said CD storage sleeve is characterized in that: said left edge and said right edge or at least one of them is provided in a horizontal diametric direction of said compact disc at least a stop point pointing inwardly, width of said CD storage sleeve at an area having said point is reduced and nearly is equal to a diameter of said compact disc to thereby prevent said compact disc placed in from dropping but not to impede placing in of said compact disc.

10. The CD storage sleeve set with multiple CD storage sleeves for more than four compact discs as claimed in claim 9, wherein another outer layer same as said outer layer is added to a back of said inner layer of each of said CD storage sleeves to form a two-side CD storage sleeve.
